(19) United States
(12) Patent Application Publication
(10) Pub. No.: US 2011/0027588 A1
(43) Pub. Date: Feb. 3, 2011

(54) MAGNETIC POWDER AND METHOD OF MANUFACTURING THE SAME

(75) Inventors: Yasushi Hattori, Odawara-shi (JP); An-Pang Tsai, Sendai-shi (JP); Satoshi Kameoka, Sendai-shi (JP)

Correspondence Address: SUGHRUE MION, PLLC, 2100 PENNSYLVANIA AVENUE, N.W., SUITE 800, WASHINGTON, DC, 20037, US

(73) Assignees: FUJIFILM Corporation, Tokyo (JP); TOHOKU UNIVERSITY, Sendai-shi (JP)

(21) Appl. No.: 12/846,107

(22) Filed: Jul. 29, 2010

(30) Foreign Application Priority Data
Jul. 30, 2009 (JP) 2009-178054
Oct. 29, 2009 (JP) 2009-248699
Mar. 17, 2010 (JP) 2010-060068
Jul. 1, 2010 (JP) 2010-150963

(51) Int. Cl. B32B 5/00; B05D 5/12

(52) U.S. Cl. 428/403; 427/130

(57) ABSTRACT

An aspect of the present invention relates to magnetic powder comprised of gathering magnetic particles, wherein the magnetic particles comprise a hard magnetic particle and a soft magnetic material deposited on a surface of the hard magnetic particle in a state where the soft magnetic material is exchange-coupled with the hard magnetic particle.

### CROSS-REFERENCE TO RELATED APPLICATIONS

This application claims the benefit of priority under 35 USC 119 to Japanese Patent Application No. 2009-178054 filed on Jul. 30, 2009, Japanese Patent Application No. 2009-248699 filed on Oct. 29, 2009, Japanese Patent Application No. 2010-060068 filed on Mar. 17, 2010 and Japanese Patent Application No. 2010-150963 filed on Jul. 1, 2010, which are expressly incorporated herein by reference in their entirety.

### BACKGROUND OF THE INVENTION

### Field of the Invention

The present invention relates to magnetic powder and to a method of manufacturing the same. More particularly, the present invention relates to magnetic powder that has magnetic characteristics suited to magnetic recording and that can be employed in a particulate magnetic recording medium, and to a method of manufacturing the same.

### Discussion of the Background

In widely employed magnetic recording media, such as video tapes, computer tapes, and disks, the smaller the particles of magnetic material, the higher the SNR becomes for a given content of magnetic material in the magnetic layer. This is advantageous for high-density recording.

However, as the size of the magnetic particles decreases, superparamagnetism ends up occurring due to thermal fluctuation, precluding use in a magnetic recording medium. By contrast, materials of high crystal magnetic anisotropy have good thermal stability due to a high potential for thermal stability. Accordingly, research has been conducted into materials of high crystal magnetic anisotropy as magnetic materials of good thermal stability. For example, high crystal magnetic anisotropy has been achieved by adding Pt to a CoCr-based magnetic material in hard disks (HD) and the like. Investigation has also been conducted into the use of CoPt, FePd, FePt, and the like as magnetic materials of higher crystal magnetic anisotropy. Further, magnetic materials containing rare earth elements, such as SmCo, NdFeB, and SmFeN, are known to be magnetic materials that do not contain expensive Pt, that are inexpensive, and that exhibit high crystal magnetic anisotropy (referred to as “Technique 1”, hereinafter).

Although materials of high crystal magnetic anisotropy afford good thermal stability, an increase in the switching magnetic field necessitates a large external magnetic field for recording, compromising recording properties. Accordingly, the Journal of the Magnetics Society of Japan 29, 239-242 (2005), which is expressly incorporated herein by reference in its entirety, describes attempts that have been made to reduce the switching magnetic field by stacking a soft magnetic layer and a hard magnetic layer formed as vapor phase films on a nonmagnetic inorganic material to produce exchange coupling interaction (referred to as “Technique 2”, hereinafter).

In metal thin-film magnetic recording media such as HD media, a glass substrate capable of withstanding high temperatures during vapor deposition is normally employed as the support. By contrast, particulate magnetic recording media affording good general-purpose properties and employing inexpensive organic material supports have been proposed in recent years, and are widely employed as video tapes, computer tapes, flexible disks, and the like. From the perspective of maintaining the general-purpose properties of such particulate media, it is difficult in practical terms to employ a magnetic material in which expensive Pt is used. Thus, the use of a magnetic material comprising a rare earth element such as in Technique 1 is conceivable. However, as set forth above, improvement of recording properties is required for magnetic materials of high crystal magnetic anisotropy.

Accordingly, the application of Technique 2 to particulate magnetic recording media is conceivable to achieve both thermal stability and recording properties. However, in Technique 2, the support is exposed to high temperatures during vapor phase film formation. Thus, it is difficult to apply this technique to nonmagnetic organic material supports usually employed in particulate magnetic recording media because these supports are of poorer heat resistance.

### SUMMARY OF THE INVENTION

Accordingly, an aspect of the present invention provides for a magnetic material that can be applied to particulate magnetic recording media and that has both high crystal magnetic anisotropy and good recording properties.

The present inventors conducted extensive research into achieving the above magnetic material, resulting in the following discoveries.

(1) Depositing a soft magnetic material onto the surface of hard magnetic particles and exchange coupling the soft magnetic material with the hard magnetic particles improved the recording properties as magnetic particles while maintaining the crystal magnetic anisotropy (a high Ku) of the hard magnetic particles. The reason for this was presumed by the present inventors to be as follows.

Exchange coupling a soft magnetic material (also referred to as a “soft magnetic phase” hereinafter) to the surface of hard magnetic particles (also referred to as a “hard magnetic phase” or “hard magnetic material” hereinafter) having high crystal magnetic anisotropy (a high Ku) resulted in the soft magnetic phase responding first to changes in the external magnetic field, changing the orientation of the spin of the soft magnetic phase. As a result, since the orientation of the spin of the hard magnetic phase that had been exchange-coupled to the soft magnetic phase could be changed, it was possible to lower the switching magnetic field of the particles. As a result, it was possible to achieve a high Ku magnetic material having a coercive force suited to magnetic recording (desirably falling within a range of equal to or higher than 80 kA/m, but less than 240 kA/m).

(2) Removing the solvent from a transition metal salt solution containing hard magnetic particles to form a deposition containing a transition metal salt on the surface of the hard magnetic particles and then conducting reductive decomposition of the transition metal salt in the deposition made it possible to obtain magnetic particles in which a hard magnetic phase and a soft magnetic phase were exchange-coupled. Magnetic powder comprised of gathering of these magnetic particles could be used to manufacture a particulate magnetic recording medium by combining the magnetic powder with a binder, solvent, and the like to form a magnetic coating material. Additionally, in Technique 2 above, since a soft magnetic layer was layered on a hard magnetic layer, a microscopic view of the interface between the hard magnetic layer and the soft magnetic layer revealed that portions of the hard magnetic particles exposed on the surface of the hard magnetic layer were in contact with the soft magnetic material. Since the magnetic particles could not be collected while this state was maintained, it was impossible to obtain magnetic powder that could be applied to particulate magnetic recording media. By contrast, the method discovered by the present inventors as set forth above can be applied as a method of manufacturing magnetic powder for use in particulate magnetic recording media.

The present invention was devised on the basis of these discoveries.

An aspect of the present invention relates to magnetic powder comprised of gathering magnetic particles, wherein the magnetic particles comprise a hard magnetic particle and a soft magnetic material deposited on a surface of the hard magnetic particle in a state where the soft magnetic material is exchange-coupled with the hard magnetic particle.

The above magnetic powder may have a coercive force in a range of equal to or higher than 80 kA/m but less than 240 kA/m.

The above magnetic powder may have a saturation magnetization ranging from 4.0×10⁻² to 2.2 A·m²/g.

In the above magnetic powder, a carbon component may be present over the hard magnetic particle on which the soft magnetic material is deposited.

The above magnetic powder may have an oxide layer over the hard magnetic particle on which the soft magnetic material is deposited.

Another aspect of the present invention relates to a method of manufacturing the above magnetic powder, which comprises:

removing a solvent from a transition metal salt solution containing hard magnetic particles to form a deposition containing a transition metal salt on a surface of the hard magnetic particles, and

forming a soft magnetic phase containing a transition metal on the surface of the hard magnetic particles by reductive decomposition of the transition metal salt in the deposition.

The above method may comprise conducting oxidation treatment following the formation of the soft magnetic phase.

In the above method, the reductive decomposition may be conducted by heating the hard magnetic particles on which the deposition has been formed in a reducing gas flow.

The above reducing gas may be a hydrocarbon-containing gas, for example, methane.

A still further aspect of the present invention relates to magnetic powder comprised of gathering magnetic particles, wherein the magnetic particles comprise hexagonal ferrite and a substance deposited on a surface of the hexagonal ferrite, the substance being selected from the group consisting of a transition metal and a compound of a transition metal and oxygen.

The above compound may comprise no alkaline earth metal.

The above transition metal may be cobalt.

The compound may be CoHO₂.

In the above magnetic powder, a carbon component may be present in an outermost layer.

The above magnetic powders may be magnetic powder employed in a particulate magnetic recording medium.

The present invention can improve the recording properties of magnetic materials having high crystal magnetic anisotropy.

Other exemplary embodiments and advantages of the present invention may be ascertained by reviewing the present disclosure and the accompanying drawing.

### BRIEF DESCRIPTION OF THE DRAWINGS

The present invention will be described in the following text by the exemplary, non-limiting embodiments shown in the FIGURE, wherein:

FIG. 1 shows composition evaluation results by X-ray diffraction of the magnetic particles obtained in Example 13 and starting material barium ferrite particles.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Magnetic Powder

The present invention relates to magnetic powder comprised of gathering magnetic particles, wherein the magnetic particles comprise a hard magnetic particle and a soft magnetic material deposited on a surface of the hard magnetic particle in a state where the soft magnetic material is exchange-coupled with the hard magnetic particle.

Hard magnetic particles have high crystal magnetic anisotropy and good thermal stability. However, due to their high crystal magnetic anisotropy, their coercive force is also high, necessitating a high external magnetic field for recording and thus compromising recording properties. By contrast, in the present invention, depositing a soft magnetic material on the surface of hard magnetic particles and causing the soft magnetic material to exchange couple with the hard magnetic particles makes it possible to control the coercive force of the magnetic particles to a level suited to recording while maintaining the crystal magnetic anisotropy (high Ku) of the hard magnetic particles. Since the magnetic particles of the present invention can exhibit both a high crystal magnetic anisotropy due to the hard magnetic particles and a coercive force suited to recording in this manner, they are suitable for use as a magnetic material in particulate magnetic recording media.

In the present invention, the term “exchange coupling” refers to coupling of a hard magnetic material and a soft magnetic region such that the spin orientation is aligned by exchange interaction, the spin of the hard magnetic material and the spin of the soft magnetic region operate in concerted fashion, and the orientation of the spin changes as a single magnetic material. When a soft magnetic phase is present on the surface of a hard magnetic phase without undergoing exchange coupling, that is, is simply physically attached, the coercive force of the hard magnetic material will not change depending on the presence or absence of the soft magnetic phase. Accordingly, the fact that a hard magnetic phase and a soft magnetic phase have exchange-coupled can be confirmed based on whether or not the coercive force of the hard magnetic material is reduced by formation of the soft magnetic phase. Further, when a soft magnetic phase is present on the surface of a hard magnetic phase without undergoing exchange coupling, the M-H loop (hysteresis loop) becomes the sum of the M-H loop of the soft magnetic phase with the M-H loop of the hard magnetic phase. Thus, in places corresponding to the coercive force of the soft magnetic phase, segments appear in the M-H loop. Accordingly, exchange coupling of a hard magnetic phase and a soft magnetic phase can be confirmed from the shape of the M-H loop.

In the present invention, the term “hard magnetism” refers to a coercive force of equal to or higher than 240 kA/m, and the term “soft magnetism” refers to a coercive force of less than 8 kA/m.

The magnetic powder of the present invention will be described in greater detail below.

In the magnetic particles that constitute the magnetic powder of the present invention, a soft magnetic material is deposited on the surface of hard magnetic particles. As set forth above, hard magnetic particles have high crystal magnetic anisotropy, and are thus thermally stable. The constant of crystal magnetic anisotropy of the hard magnetic particles is desirably equal to or greater than 1×10⁻¹ J/cc (1×10⁶ erg/cc), preferably equal to or greater than 6×10⁻¹ J/cc (6×10⁶ erg/cc). The higher the crystal magnetic anisotropy, the smaller the magnetic particles can be, which is advantageous in terms of electromagnetic characteristics such as the S/N ratio. When the constant of crystal magnetic anisotropy of the hard magnetic particles is equal to or greater than 1×10⁻¹ J/cc (1×10⁶ erg/cc), a coercive force that is suited to magnetic recording can be maintained when exchange interacted with the soft magnetic material to impart exchange coupling. When the constant of crystal magnetic anisotropy of the hard magnetic particles exceeds 6 J/cc (6×10⁷ erg/cc), the coercive force is high and recording properties may deteriorate even when exchange coupled with the soft magnetic phase. Thus, the constant of crystal magnetic anisotropy of the hard magnetic particles desirably does not exceed 6 J/cc (6×10⁷ erg/cc).

From the perspective of recording properties, the saturation magnetization of the hard magnetic particles is desirably 0.5×10⁻¹ to 2 A·m²/g (50 to 2,000 emu/g), preferably 5×10⁻¹ to 1.8 A·m²/g (500 to 1,800 emu/g). They can be of any shape, such as spherical or polyhedral. From the perspective of high-density recording, the size (diameter, plate diameter, etc.) of the hard magnetic particles is desirably 3 to 100 nm, preferably 5 to 10 nm. The “particle size” in the present invention can be measured by a transmission electron microscope (TEM). The average particle size in the present invention is defined as the average value of the particle sizes of 500 particles randomly extracted and measured in a photograph taken by a transmission electron microscope.

Examples of the hard magnetic particles are magnetic materials comprised of rare earth elements and transition metal elements; oxides of transition metals and alkaline earth metals; and magnetic materials comprised of rare earth elements, transition metal elements, and metalloids (also referred to as “rare earth—transition metal—metalloid magnetic materials” hereinafter). From the perspective of obtaining a suitable constant of crystal magnetic anisotropy set forth above, rare earth—transition metal—metalloid magnetic materials and hexagonal ferrite are desirable. Depending on the type of hard magnetic particle, there are times when oxides such as rare earth oxides will be present on the surface of the hard magnetic particle. Such hard magnetic particles are also included among the hard magnetic particles in the present invention.

More detailed descriptions of rare earth—transition metal—metalloid magnetic materials and hexagonal ferrite are given below.

### (Rare Earth—Transition Metal—Metalloid Magnetic Material)

Examples of rare earth elements are Y, Ce, Pr, Nd, Sm, Gd, Tb, Dy, Ho, Er, Tm, and Lu. Of these, Y, Ce, Pr, Nd, Gd, Tb, Dy, Ho, Pr, Nd, Tb, and Dy, which exhibit single-axis magnetic anisotropy, are preferred; Y, Ce, Gd, Ho, Nd, and Dy, which having constants of crystal magnetic anisotropy of 6×10⁻¹ J/cc to 6 J/cc (6×10⁶ erg/cc to 6×10⁷ erg/cc), are of greater preference; and Y, Ce, Gd, and Nd are of even greater preference.

The transition metals Fe, Ni, and Co are desirably employed to form ferromagnetic materials. When employed singly, Fe, which has the greatest crystal magnetic anisotropy and saturation magnetization, is desirably employed.

Examples of metalloids are boron, carbon, phosphorus, silicon, and aluminum. Of these, boron and aluminum are desirably employed, with boron being optimal. That is, magnetic materials comprised of rare earth elements, transition metal elements, and boron (referred to as “rare earth—transition metal—boron magnetic materials”, hereinafter) are desirably employed as the above hard magnetic phase. Rare earth—transition metal—metalloid magnetic materials including rare earth—transition metal—boron magnetic materials are advantageous from a cost perspective in that they do not contain expensive noble metals such as Pt, and can be suitably employed to fabricate magnetic recording media with good general-purpose properties.

The composition of the rare earth—transition metal—metalloid magnetic material is desirably 10 atomic percent to 15 atomic percent rare earth, 70 atomic percent to 85 atomic percent transition metal, and 5 atomic percent to 10 atomic percent metalloid.

When employing a combination of different transition metals as the transition metal, for example, the combination of Fe, Co, and Ni, denoted as Fe(_{1-x-y}) CoₓNi_{y}, desirably has a composition in the ranges of x=0 atomic percent to 45 atomic percent and y=25 atomic percent to 30 atomic percent; or the ranges of x=45 atomic percent to 50 atomic percent and y=0 atomic percent to 25 atomic percent, from the perspective of ease of controlling the coercive force of the hard magnetic material to the range of 240 kA/m to 638 kA/m (3,000 Oe to 8,000 Oe).

From the perspective of low corrosion, the ranges of x=0 atomic percent to 45 atomic percent and y=25 atomic percent to 30 atomic percent, or the ranges of x=45 atomic percent to 50 atomic percent and y=10 atomic percent to 25 atomic percent, are desirable.

From the perspective of achieving good temperature characteristics with a Curie point of equal to or higher than 500° C., the ranges of x=20 atomic percent to 45 atomic percent and y=25 atomic percent to 30 atomic percent, or the ranges of x=45 atomic percent to 50 atomic percent and y=0 atomic percent to 25 atomic percent, are desirable.

Accordingly, from the perspectives of coercive force, corrosion, and temperature characteristics, the ranges of x=20 atomic percent to 45 atomic percent and y=25 atomic percent to 30 atomic percent or the ranges of x=45 atomic percent to 50 atomic percent and y=10 atomic percent to 25 atomic percent are desirable, and the ranges of x=30 atomic percent to 45 atomic percent and y=28 atomic percent to 30 atomic percent are preferred.

The above hard magnetic particles can be synthesized by a vapor phase method or a liquid phase method. However, high temperatures are required to synthesize a magnetic material of high crystal magnetic anisotropy. Thus, from the perspective of the heat resistance of the support, it is usually difficult to synthesize such a magnetic material on the nonmagnetic organic supports that are generally employed as supports in particulate magnetic recording media. Accordingly, the hard magnetic particles should be synthesized prior to being coated on a nonmagnetic organic support.

One method of obtaining a rare earth—transition metal—boron magnetic material comprises melting the starting material metals in a high-frequency melting furnace and then conducting casting. In this method, since a product containing a large amount of transition metal as primary crystals is obtained, it is necessary to conduct solution heat treatment directly below the melting point to eliminate the transition metal. Since the particle size increases in solution heat treatment, it is desirable to employ the synthesis method set forth further below to obtain a microparticulate magnetic material suited to high-density recording.

In the quenching method in which molten metal is poured onto rotating rolls (molten metal quenching method), Fe in the form of primary crystals is not produced, making it possible to obtain microparticulate (desirably, with a particle size of 3 nm to 200 nm) rare earth—transition metal—boron nanocrystals in a thin quenched band.

Further, forming an amorphous alloy by the quenching method of pouring molten metal onto rotating rolls, followed by the method of conducting a heat treatment at 400° C. to 1,000° C. in a nonoxidizing atmosphere (such as an inert gas, nitrogen, or a vacuum) to precipitate nanocrystals can yield microparticulate (desirably, with a particle size of 3 nm to 200 nm) rare earth—transition metal—boron nanocrystals.

When employing a molten metal quenching method on an alloy, it is desirable to employ an inert gas atmosphere to prevent oxidation. Specific examples of inert gases that are desirably employed are He, Ar, and N₂.

In the molten metal quenching method, the quenching rate is determined based on the rotational speed of the rolls and the thickness of the thin quenched band. In the present invention, the rotational speed of the rolls in the course of forming rare earth—transition metal—boron nanocrystals in the thin quenched band immediately following quenching is desirably 10 m/s to 25 m/s. The rotational speed of 25 m/s to 50 m/s is desirable to obtain an amorphous alloy once following quenching.

The thickness of the thin quenched band is desirably 10 μm to 100 μm. It is desirable to control the quantity of molten metal that is poured by means of the orifice or the like to permit a thickness within the above range.

Subsequently, microparticles can be obtained using the method of microparticulating the particles in the course of adsorbing and desorbing hydrogen (the HDDR method), or by gas flow dispersion or wet dispersion.

### (Hexagonal Ferrite)

Examples of hexagonal ferrite are barium ferrite, strontium ferrite, lead ferrite, calcium ferrite, and various substitution products thereof such as Co substitution products. Specific examples are magnetoplumbite-type barium ferrite and strontium ferrite; magnetoplumbite-type ferrite in which the particle surfaces are covered with spinels; and magnetoplumbite-type barium ferrite, strontium ferrite, and the like partly comprising a spinel phase. The following may be incorporated into the hexagonal ferrite in addition to the prescribed atoms: Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb and the like. Compounds to which elements such as Co—Zn, Co—Ti, Co—Ti—Zr, Co—Ti—Zn, Ni—Ti—Zn, Nb—Zn—Co, Sb—Zn—Co, and Nb—Zn have been added may generally also be employed. They may comprise specific impurities depending on the starting materials and manufacturing methods employed; such hexagonal ferrite may be employed in the present invention.

The soft magnetic material that is deposited on the surface of the hard magnetic particles will be described next.

From the perspectives of exchange coupling with the hard magnetic particles and controlling the coercive force of the magnetic particles at a level that is suited to magnetic recording, the constant of crystal magnetic anisotropy of the soft magnetic material is desirably as low as possible, and the selection of a soft magnetic material with a negative value is acceptable. However, when a soft magnetic material having a negative constant of crystal magnetic anisotropy is exchange-coupled with hard magnetic particles, the magnetic energy of the magnetic particles ends up being low. Thus, the constant of crystal magnetic anisotropy of the soft magnetic material is desirably 0 to 5×10⁻² J/cc (0 to 5×10⁵ erg/cc), preferably 0 to 1×10⁻² J/cc (0 to 1×10⁵ erg/cc).

From the perspectives of exchange coupling with the hard magnetic particles and controlling the coercive force of the magnetic particles at a level that is suited to magnetic recording, the saturation magnetization of the soft magnetic material is desirably as high as possible. Specifically, it desirably falls within a range of 1×10⁻¹ to 2 A·m²/g (100 emu/g to 2,000 emu/g), preferably within a range of 3×10⁻¹ to 1.8 A·m²/g (300 to 1,800 emu/g).

Fe, an Fe alloy, or an Fe compound, such as iron, permalloy, sendust, or soft ferrite, is desirably employed as the soft magnetic material. The soft magnetic material can be selected from the group consisting of transition metals and compounds of transition metals and oxygen. Examples of transition metals are Fe, Co, and Ni. Fe and Co are desirable. When the hard magnetic particles are hexagonal ferrite, Co is preferred. This compound desirably comprises hydrogen in addition to a transition metal and oxygen, such as in CoHO₂, the presence of which is confirmed in Examples described further below. The soft magnetic material that is deposited on the hard magnetic particles can be a compound that does not contain an alkaline earth metal, such as is indicated in Examples set forth further below. The soft magnetic material can be present as an amorphous or crystalline substance on the surface of the hard magnetic particles. In this context, the term “amorphous substance” means that it is undetected as a diffraction peak in analysis by X-ray diffraction, and “crystalline substance” means that it is detected as a diffraction peak.

From the perspective of controlling the coercive force of the magnetic particles to a level suited to magnetic recording in the course of coupling, the exchange coupling energy between the hard magnetic particles and the soft magnetic material in the magnetic particles of the present invention is desirably adjusted to an optimal level based on the constant of crystal magnetic anisotropy of the hard magnetic particles. Specifically, the constant of crystal magnetic anisotropy of the soft magnetic material is desirably 0.01 to 0.3-fold that of the hard magnetic particles.

The exchange coupling energy can be adjusted by means of impurities at the interface, distortion, the crystalline structure, and the like.

The magnetic particle constituting the magnetic powder of the present invention comprises a hard magnetic particle and a soft magnetic material deposited on a surface of the hard magnetic particle in a state where the soft magnetic material is exchange-coupled with the hard magnetic particle. From the perspective of controlling the coercive force of the magnetic particles to a level suited to magnetic recording, the ratio accounted for by the soft magnetic material in the magnetic particle constituting the magnetic powder of the present invention is desirably determined based on the coercive force of the hard magnetic particle. Taking into account the type of hard magnetic particle and the type of soft magnetic material that is deposited, the volumetric ratio of the hard magnetic particle to the soft magnetic material (hard magnetic particle/soft magnetic material) can be adjusted to achieve the desired coercive force. In one embodiment, it is, for example, 2/1 to 1/20, and can also be 1/1 to 1/15. In another embodiment, it is, for example, 500/1 to 1/20, and can also fall within a range of 200/1 to 1/20. When the hard magnetic particle is hexagonal ferrite, in the magnetic particle obtained by depositing a soft magnetic material on the hexagonal ferrite (hard magnetic particle) with exchange coupling of the soft magnetic material and the hexagonal ferrite, the ratio accounted for by the soft magnetic material is desirably less than 2 weight percent, preferably falling within a range of 0.1 to 1 weight percent. In the magnetic particle constituting the magnetic powder of the present invention, the thickness of the soft magnetic material that is deposited on the hard magnetic particle is not specifically limited. However, it is desirably set to a suitable value to achieve the above volumetric ratio, for example, based on the volume of the hard magnetic particle. Further, the magnetic particles contained in the magnetic powder of the present invention may have a core/shell structure in which a soft magnetic material constituting a deposition (shell) is present on the surface of a core in the form of a hard magnetic particle. That is, the magnetic powder of the present invention is comprised of gathering core/shell magnetic particles comprising a deposition of a soft magnetic phase on the surface of a hard magnetic phase, with the soft magnetic phase and the hard magnetic phase being exchange-coupled. However, in the magnetic powder of the present invention, a soft magnetic material may be deposited with exchange coupling to at least a portion of the surface of the hard magnetic particle; it is not necessary for the soft magnetic material to be coated over the entire surface of the hard magnetic particle. Accordingly, even when there are portions where the hard magnetic particle is exposed and portions where other materials are deposited, such structures are included in the core/shell magnetic particles in the present invention. The magnetic powder of the present invention clearly differs from the above-mentioned Technique 2—in which a structure is formed where the hard magnetic layer comprised of the hard magnetic material contacts with the soft magnetic layer comprised of the soft magnetic material—in that a structure where the soft magnetic material is deposited on the surface of the hard magnetic particle has been adopted for each individual magnetic particle.

The magnetic particles may comprise an oxide layer over the hard magnetic particles on which the soft magnetic material is deposited. The oxide layer can be formed by the usual slow oxidation treatment of the magnetic particles once the soft magnetic material has been deposited on the hard magnetic powder. The formation of an oxide layer as the outermost layer by slow oxidation treatment can increase the storage stability and enhances the handling properties of the magnetic particles.

However, there are times when it is desirable not to form the oxide layer from the perspective of magnetic characteristics. The portion that is oxidized by the slow oxidation treatment is mainly the outermost layer portion of the soft magnetic material. However, oxidation will sometimes compromise the magnetism of the outermost layer portion. By contrast, the formation of a carbon component on the surface of the magnetic particles as set forth further below is desirable from the perspective of increasing the storage stability and enhancing the handling properties through the presence of the carbon component.

The diameter of the magnetic particles is desirably 5 to 200 nm, preferably 5 to 25 nm. This is because microparticles are desirable in terms of electromagnetic properties such as the S/N ratio. However, when excessively small, the hard magnetic particles exhibit superparamagnetism and become unsuitable for recording. In a structure in which a soft magnetic material is deposited on the hard magnetic particles, the hard magnetic particles are smaller than the magnetic particles on which a deposition has been applied. This requirement is more stringent than for single particles. On the other hand, when the particle diameter exceeds 200 nm, particles that are suitable for recording and reproduction will be present among the magnetic particles in a single-component structure. Particles with diameters of equal to or less than 200 nm, at which size it is difficult to obtain single-component magnetic particle suited to recording and reproduction, are desirable.

The magnetic powder of the present invention can achieve a coercive force that is suited to recording by exchange coupling hard magnetic particles with a soft magnetic material when the hard magnetic particles alone have a high coercive force that is unsuited to recording. That is, a coercive force that is suited to recording can be achieved because the spin of the hard magnetic particles will tend to change due to the effect of the spin in the exchange-coupled (interactively exchange coupled) soft magnetic material. The coercive force of the magnetic powder of the present invention is lower than the coercive force of the hard magnetic particles because the soft magnetic material is exchange-coupled to the hard magnetic particles. It desirably falls within a range of equal to or higher than 80 kA/m but less than 240 kA/m. When the coercive force is excessively low, it becomes difficult to maintain recording due to the effect of adjacent recorded bits, and thermal stability deteriorates. When the coercive force is excessively high, recording becomes impossible. The coercive force is preferably equal to or higher than 160 kA/m but less than 240 kA/m. As set forth above, the coercive force of the hard magnetic material constituting the hard magnetic particles is equal to or higher than 240 kA/m and the coercive force of the soft magnetic material is equal to or lower than 8 kA/m. The upper and lower limits are not specifically limited. The coercive force of generally available hard magnetic material is normally 1,000 kA/m or less, and the coercive force of generally available soft magnetic material is normally equal to or higher than 0.04 kA/m.

The saturation magnetization can be increased relative to the hard magnetic particles alone by interactively exchange coupling the spin of the hard magnetic particles and the spin of the soft magnetic material as set forth above. Thus, a saturation magnetization falling within a range of 4.0×10⁻² to 2.2 A·m²/g (40 to 2,200 emu/g) can be achieved in the magnetic powder of the present invention. A saturation magnetization falling within this range is advantageous in terms of output. The saturation magnetization of the magnetic powder of the present invention is preferably 5.4×10⁻² to 2.2 A·m²/g (54 to 2,200 emu/g), more preferably 1×10⁻¹ to 2.2 A·m²/g (100 to 2,200 emu/g), and still more preferably, falls within a range of 1.2×10⁻¹ to 1.8 A·m²/g (120 to 1,800 emu/g).

### Method of Manufacturing Magnetic Powder

The present invention further relates to the method of manufacturing above-mentioned magnetic powder of the present invention. The manufacturing method of the present invention comprises:

removing a solvent from a transition metal salt solution containing hard magnetic particles to form a deposition containing a transition metal salt on a surface of the hard magnetic particles (the “first step” hereinafter), and

forming a soft magnetic phase containing a transition metal on the surface of the hard magnetic particles by reductive decomposition of the transition metal salt in the deposition (the “second step” hereinafter).

The manufacturing method of the present invention yields the magnetic powder of the present invention being comprised of gathering magnetic particles, wherein the magnetic particles comprise a hard magnetic particle and a soft magnetic material deposited on a surface of the hard magnetic particle in a state where the soft magnetic material is exchange-coupled with the hard magnetic particle. With Technique 2 set forth above, it is impossible to obtain such magnetic powder, as described above. Accordingly, Technique 2 cannot be readily applied to particulate magnetic recording media. By contrast, the manufacturing method of the present invention can be applied as a method for manufacturing magnetic powder for use in particulate magnetic recording media.

The manufacturing method of the present invention will be described in greater detail below.

### First Step

In the first step, the solvent is removed from a transition metal salt solution containing hard magnetic particles (also referred to as a “hard magnetic particle-containing salt solution” or, simply, “salt solution” hereinafter) to form a deposition containing a transition metal salt on the surface of the hard magnetic particles. The details of the hard magnetic particles are as set forth above.

The salt employed in the first step need only be the salt of a transition metal. To form a soft magnetic material following reductive decomposition, a salt of Fe, Co, or Ni is desirable, and a salt of Fe or Co is preferred. The salt may be organic or inorganic. Specifically, iron chloride, iron citrate, ferric ammonium citrate, iron sulfide, iron acetate, iron (III) acetylacetonate, ferric ammonium oxalate, cobalt chloride, cobalt citrate, cobalt sulfide, cobalt (III) acetylacetonate, nickel chloride, nickel sulfide, and the like can be employed. The salt may include transition metal complexes (complex salts). In the course of reductive decomposition, the salt is desirably an inorganic compound from the perspective of removing by-products.

The solvent of the above solution is not specifically limited other than that it be capable of dissolving the transition metal salt employed. Known solvents may be employed. However, solvents with high boiling points are undesirable from the perspective of facilitating removal of the solvent. In this regard, water, ketones (such as acetone), alcohols, and ethers are desirably employed. From the perspective of preventing oxidation in the course of immersion of the hard magnetic phase, the use of a solvent from which the oxygen has been removed by bubbling nitrogen or the like is desirable. In this process, volatization of the solvent employed can be prevented by using nitrogen gas that has been passed through the solvent in advance. It is also possible to use an oily solvent, but the use of a non-oily solvent is desirable from the perspective of facilitating removal of the solvent. In this regard, water, ketones, alcohols, and ethers are desirably employed.

The concentration of the salt in the salt solution is not specifically limited. However, when the salt concentration of the salt solution is excessively low, it becomes necessary to repeat the operation of immersing the hard magnetic particles in the salt solution, removing the solvent, precipitating the salt on the surface of the hard magnetic particles, and conducting reductive decomposition of the salt multiple times to form a soft magnetic phase of desired quantity on the surface of the hard magnetic particles. Further, an excessively high concentration is undesirable in that the particles end up clumping together in the course of immersing the hard magnetic particles in the salt solution, removing the solvent, and precipitating the salt on the surface of the hard magnetic particles. Taking the above factors into account, the salt concentration in the salt solution is desirably about 0.1 to 20 mmole per 100 g of solution.

From the perspective of uniformly adhering the salt to the surface of the particles, the quantity of magnetic particles in the salt solution is desirably about the quantity required to uniformly wet the surface of the hard magnetic particles. This is because when dry portions remain on the particle surface, adhesion of the salt becomes nonuniform, and when the salt solution is excessive, nonuniformities develop in the salt solution in the course of removing the solvent, resulting in nonuniformities in salt adhesion.

The method of preparing the salt solution is not specifically limited. It suffices to prepare it by simultaneously or successively admixing the hard magnetic particles and the transition metal salt with the solvent.

From the perspective of preventing oxidation of the hard magnetic particles, the atmosphere from the operation of immersing the hard magnetic particles in the solution up to the second step is desirably an inert atmosphere such as a nitrogen, argon, or helium atmosphere.

Following preparation of the salt solution containing the hard magnetic particles, the solvent is removed from the solution that has been prepared to cause the transition metal salt to precipitate out onto the surface of the hard magnetic particles. This permits the formation of a deposition containing the transition metal salt on the surface of the hard magnetic particles. Thermoprocessing, reduced pressure processing, or a combination of the two can be used to readily remove the solvent from the salt solution containing the hard magnetic particles. The heating temperature in thermoprocessing can be set based on the boiling point of the solvent. However, even when conducting processing in an inert atmosphere as set forth above, an excessively high temperature will sometimes result in oxidation of the hard magnetic particles by oxygen contained as an impurity in the atmosphere. From the perspective of preventing such oxidation, the heating temperature is desirably about 25 to 250° C., preferably about 25 to 150° C. In the course of removing the solvent by heating, the particles tend to aggregate. Thus, the use of a low temperature for a longer period is desirable to remove the solvent. In the removal of the solvent, suitable stirring of the salt solution can promote uniform precipitation of the transition metal salt on the surface of the hard magnetic particles. Further, to prevent oxidation and prevent aggregation of particles, it is desirable to remove the solvent by processing under reduced pressure. The reduced pressure processing can be conducted at a reduced pressure of 0.1 to 8,000 Pa with an aspirator or rotary pump. In this process, the solvent that is removed is desirably removed with a cold trap. Since the heat of vaporization accompanying volatization of the solvent during reduced pressure processing will cause the temperature of the sample to drop, reducing the efficiency of solvent removal, heating to 25 to 50° C. is desirable.

In the first step, the above operations can form a deposition containing the transition metal salt on the surface of the hard magnetic particles. The thickness of the deposition can be suitably adjusted by means of, for example, the salt concentration in the salt solution so as to permit the formation of the desired quantity of soft magnetic phase on the surface of the hard magnetic particles. The deposition formed in this step does not have to cover the entire surface of the hard magnetic particle. It is permissible for portions where the surface of the hard magnetic particle is exposed and portions where other substances are deposited to remain.

### Second Step

In the second step, the transition metal salt in the deposition that was formed in the first step is subjected to reductive decomposition to form a soft magnetic phase containing a transition metal on the surface of the hard magnetic particles. The reductive decomposition is desirably conducted by heating hard magnetic particles on which the deposition has been formed in a reducing atmosphere. A reducing gas in the form of hydrogen, carbon monoxide, or a hydrocarbon can be employed. Hydrogen and carbon monoxide are desirable in that they oxidize during reductive decomposition, and are eliminated from the particles as gas in the form of water and carbon dioxide. From the perspective of the reaction efficiency of the reductive decomposition, the atmospheric gas during reductive decomposition is desirably one that contains equal to or more than 50 volume percent, preferably equal to or more than 90 volume percent, of a reducing gas. Providing a gas inlet and gas outlet in the reaction vessel and discharging the gas following the reaction while constantly introducing a reducing gas flow during reductive decomposition is preferred from the perspective of reaction efficiency. Conducting reductive decomposition in a reducing gas flow is advantageous in that Ca impurities are not introduced through Ca reduction or the like and by-products of reductive decomposition are carried away in the gas phase. In view of safety, hydrogen that has been diluted with an inert gas is also desirably employed. However, in such cases, reductive decomposition take a long time.

There are also cases in which it is desirable to conduct the reduction reaction in a moderate manner from the perspective of equipment. Since hard magnetic particles that are oxides (such as hexagonal ferrite) readily reduce, the use of a reducing gas of great reducing strength will sometimes reduce and decompose the entire hard magnetic particle even after a deposition has been formed on its surface. Thus, the reduction reaction is desirably conducted in a moderate fashion. In that case, it is desirable to employ a reducing gas of relatively low reducing strength. Alternatively, the concentration of the reducing gas in the atmospheric gas during reductive decomposition can be suitably reduced, for example, up to about 5 volume percent.

Hydrocarbons are reducing gases that are desirable when conducting the reduction reaction in a moderate fashion as set forth above. The hydrocarbon is not specifically limited, and may be saturated or unsaturated. Specific examples are methane, ethane, propane, butane, and other saturated hydrocarbons, and ethylene, acetylene, and other unsaturated hydrocarbons. From the perspective of facilitating handling, methane and ethane are desirable, with the use of methane being preferable. The use of a hydrocarbon that has been diluted with an inert gas such as nitrogen is desirable to adjust the reducing strength. This embodiment is also desirable from the perspective of safety because the gases employed are in the form of incombustible gases. The present inventors presume that when employed a hydrocarbon as the reducing gas, oxidation of the hydrocarbon accompanying reduction produces carbon and/or carbide (collectively referred to as “carbon components” in the present invention) on the surface of the deposition. As indicated in Examples described further below, the presence of a carbon component (graphite) was determined on the outermost surface of the magnetic particles following reductive decomposition (that is, the outermost layer of the magnetic particles having a structure consisting of a soft magnetic material deposited on the surface of hard magnetic particles). Accordingly, one embodiment of the present invention provides magnetic particles in which a carbon component is present on hard magnetic particles that have been deposited with a soft magnetic material. The reason the present inventors felt it was desirable to use a hydrocarbon as the reducing gas when faced with the need to conduct a moderate reduction reaction was that the carbon component played a role of inhibiting excessive reduction.

A heating temperature in the atmosphere containing a reducing gas that is excessively low is undesirable when conducting reductive decomposition in the atmosphere containing a reducing gas because a long time is required for reductive decomposition and operating efficiency is poor. A heating temperature that is excessively high would be dangerous if the reducing gas were to leak. From these perspectives, in the atmosphere containing a reducing gas, particularly in reductive decomposition in a hydrogen gas flow, the heating temperature desirably falls within a range of 300 to 550° C. The discharged gas can be processed with a scrubber to remove by-products in the course of the reductive decomposition of a transition metal salt.

The above step makes it possible to reduce the transition metal salt in the deposition on the surface of the hard magnetic particles to a transition metal. This permits the formation of a soft magnetic phase containing a transition metal on the surface of the hard magnetic particles. A soft magnetic material and hard magnetic particles are present in an exchange-coupled state within the magnetic particles thus formed. The fact that a soft magnetic material and hard magnetic particles are exchange-coupled in the magnetic particles that have been formed can be confirmed by the methods set forth above. Using the above-described solvent, for example, to clean away any unreacted portions of transition metal salt employed as starting material to form the soft magnetic phase that may be present following reductive decomposition in the soft magnetic phase of the magnetic particles is desirable from the perspective of magnetic characteristics.

Oxidation treatment (slow oxidation treatment) of the magnetic particles following reductive decomposition is desirable to form an oxide layer on the outermost layer. That is because the particles tend to catch fire following reduction processing, should be handled in an inert gas, and are difficult to handle. Oxidation processing can be conducted by a known slow oxidation treatment. However, as set forth above, magnetic particles in which a carbon component is present can afford good handling properties without the formation of an oxide layer.

The magnetic powder of the present invention can be obtained by the manufacturing method of the present invention as set forth above. However, the magnetic powder of the present invention is not limited to magnetic powders obtained by the manufacturing method of the present invention, and need only be comprised of gathering magnetic powders in which a soft magnetic material is deposited in an exchange-coupled form on the surface of hard magnetic particles.

The present invention further provides magnetic powder comprised of gathering magnetic particles, wherein the magnetic particles comprise hexagonal ferrite and a substance deposited on a surface of the hexagonal ferrite, the substance being selected from the group consisting of a transition metal and a compound of a transition metal and oxygen, as described in Examples further below. The above magnetic powder can exhibit a lower coercive force than the hexagonal ferrite, as indicated in Examples. Accordingly, it becomes possible to achieve good recording properties while maintaining the high thermal stability resulting from the crystalline structure of hexagonal ferrite.

For details regarding this magnetic powder, reference can be made to explanations for the magnetic powder and method of manufacturing the same that are set forth above.

Since the magnetic powder of the present invention can be manufactured without requiring the high-temperature processing on a support that is required by Technique 2 set forth above, the magnetic powder of the present invention can be mixed with a binder and solvent, and coated as a coating liquid on a support to form the magnetic layer. Accordingly, the magnetic powder of the present invention is suited to application to particulate magnetic recording media.

### EXAMPLES

The present invention will be described in detail below based on Examples. However, the present invention is not limited to the examples.

### Examples 1 to 8

### Examples Employing Nd₂Fe₁₄B as the Hard Magnetic Phase

Magnetic powder comprised of gathering hard magnetic particles of Nd₂Fe₁₄B composition that had been prepared by HDDR method (Hc: 734 kA/m, saturation magnetization: 1.42×10⁻¹ A·m²/g (142 emu/g), average crystal particle diameter: 100 nm) was immersed in the salt solution (0.5 g of solution per gram of magnetic powder) indicated in Table 1 in such a manner as to wet the surface of the particles, and heated to 110° C. in a nitrogen atmosphere to remove the solvent. In this process, the particles in the salt solution were stirred once every 30 minutes.

The dry powder obtained by removing the solvent was processed for one hour at 400° C. in a hydrogen gas flow to subject to reductive decomposition the Fe salt contained in the deposition on the surface of the particles. During reductive decomposition, the hydrogen gas that was discharged contained by-products during the course of salt decomposition, and was thus processed with a scrubber. Subsequently, the temperature was lowered to room temperature, the atmosphere in the reaction vessel was replaced with a nitrogen atmosphere, and the powder was removed.

Subsequently, the magnetic powders of Examples 3 and 6 in Table 1 were heated to 70° C. in a nitrogen atmosphere. While maintaining a temperature of 70° C., the nitrogen was mixed with air to gradually increase the concentration of oxygen to 0.35 volume percent and a surface oxidation treatment (slow oxidation treatment) was conducted.

The above step yielded a magnetic powder comprised of gathering core/shell magnetic particles in which the core was comprised of ND₂Fe₁₄B hard magnetic phase and the shell was comprised of Fe-containing soft magnetic phase.

### Comparative Example 1

Magnetic powder comprised of gathering hard magnetic particles of Nd₂Fe₁₄B composition that had been prepared by HDDR method (Hc: 734 kA/m, saturation magnetization: 1.42×10⁻¹ A·m²/g (142 emu/g), and average crystal particle diameter: 100 nm) was employed as is as the magnetic powder in Comparative Example 1.

### Evaluation of Magnetic Powders

(1) Evaluation of Magnetic Characteristics

The magnetic characteristics of the magnetic powders comprised of core/shell magnetic particles obtained in Examples 1 to 8 and the magnetic powder of Comparative Example 1 were evaluated under conditions of an applied magnetic field of 3,184 kA/m (40 kOe) with a superconducting vibrating sample magnetometer (VSM) made by Tamagawa Co. To prevent fast oxidation, the various magnetic powders were sealed in acrylic containers in nitrogen atmospheres for evaluation.

(2) Composition Evaluation

The Fe/Nd ratio (atomic ratio) of the magnetic particles constituting the various magnetic powders was measured with a model HD2300 STEM (200 kV) made by Hitachi.

(3) Handling Property (Rise in Temperature in Air)

The various magnetic powders were charged to an alumina crucible in a draft and a determination was made as to whether or not the temperature rose when placed in air.

TABLE 1

| | | Quantity | | | | |
|---|---|---|---|---|---|---|
| | | of salt | | | | |
| | | per 100 g of | Coercive | | | Rise in |
| | | solution | Force | Saturation | Composition | temperature |
| Sample | Salt/solvent | (mmol) | (kA/m) | magnetization | Fe/Nd | in air |
| Ex. 1 | Iron (II) | 3.5 | 200 | 1.52 × 10⁻¹ A · m²/g | 6.5 | Observed |
| | chloride | | | (152 emu/g) | | |
| | tetrahydrate/ | | | | | |
| | water | | | | | |
| Ex. 2 | Iron (II) | 5.25 | 120 | 1.52 × 10⁻¹ A · m²/g | 6.8 | Observed |
| | chloride | | | (152 emu/g) | | |
| | tetrahydrate/ | | | | | |
| | water | | | | | |
| Ex. 3 | Iron (II) | 5.25 | 110 | 1.44 × 10⁻¹ A · m²/g | 6.8 | None |
| | chloride | | | (144 emu/g) | | |
| | tetrahydrate/ | | | | | |
| | water | | | | | |
| Ex. 4 | Ferric | 3.5 | 190 | 1.52 × 10⁻¹ A · m²/g | 6.3 | Observed |
| | ammonium | | | (152 emu/g) | | |
| | citrate/water | | | | | |
| Ex. 5 | Ferric | 5.25 | 110 | 1.51 × 10⁻¹ A · m²/g | 6.5 | Observed |
| | ammonium | | | (151 emu/g) | | |
| | citrate/water | | | | | |
| Ex. 6 | Ferric | 5.25 | 105 | 1.44 × 10⁻¹ A · m²/g | 6.5 | None |
| | ammonium | | | (144 emu/g) | | |
| | citrate/water | | | | | |
| Ex. 7 | Iron (II) | 35 | 40 | 1.52 × 10⁻¹ A · m²/g | 8.2 | Observed |
| | chloride | | | (152 emu/g) | | |
| | tetrahydrate/ | | | | | |
| | water | | | | | |
| Ex. 8 | Ferric | 35 | 35 | 1.51 × 10⁻¹ A · m²/g | 8.3 | Observed |
| | ammonium | | | (151 emu/g) | | |
| | citrate/water | | | | | |
| Comp. | None | None | 734 | 1.42 × 10⁻¹ A · m²/g | 6.0 | Observed |
| Ex. 1 | | | | (142 emu/g) | | |

### Evaluation Results

In Table 1, the composition of Comparative Example 1 is the Fe/Nd composition ratio of magnetic particles without a soft magnetic phase, that is, the Fe/Nd composition of hard magnetic particles with a composition of Nd₂Fe₁₄B. The values of the Fe/Nd composition ratios of Examples 1 to 8 were higher than the value of Comparative Example 1. Thus, in Examples 1 to 8, Fe was determined to be present in a soft magnetic phase on the surface of the hard magnetic particles.

The coercive force of the magnetic powders of Examples 1 to 8 was lower than the coercive force of the magnetic powder of Comparative Example 1. Thus, a soft magnetic phase exchange-coupled to a hard magnetic phase was determined to be present on the surface of the hard magnetic particles (hard magnetic phase) in the magnetic powders of Examples 1 to 8. Due to high crystal magnetic anisotropy, the hard magnetic phase had good thermal stability. However, the coercive force was high and thus a large external magnetic field was required for recording, rendering recording difficult. By contrast, in the present invention, the core and shell in a core/shell structure with a core in the form of a hard magnetic phase and a shell in the form of a soft magnetic phase as set forth above were exchange-coupled. This permitted a decrease in coercive force of the magnetic particles and achieved a coercive force within a range of equal to or higher than 80 kA/m but less than 240 kA/m in Examples 1 to 6, suitable to recording. Thus, the present invention improved the recording properties of hard magnetic particles with good thermal stability.

Further, the saturation magnetization of the magnetic powders of Examples 1 to 8 were higher than the saturation magnetization of the magnetic powder of Comparative Example 1. Thus, exchange coupling of the soft magnetic phase to the hard magnetic phase was confirmed to increase the saturation magnetization.

From the results in Table 1, it was found that the salt concentration could be used to control the quantity of soft magnetic phase on the hard magnetic particles, that this permitted the adjustment of the coercive force and saturation magnetization of the magnetic powder, and that slow oxidation treatment improved handling properties.

### Examples 9 to 12

### Examples Employing Barium Ferrite as the Hard Magnetic Phase

Magnetic powder comprised of gatheing particles of barium ferrite (referred to as “BaFe” hereinafter) (Hc: 270 kA/m, saturation magnetization: 5.2×10⁻² A·m²/g (52 emu/g), average plate diameter: 35 nm, average plate thickness: 8 nm) was immersed in the salt solution (1 gram of solution per gram of BaFe powder) described in Table 2 so as to wet the surface of the particles. The solvent was removed while reducing the pressure with an aspirator. In this process, the particles in the salt solution were stirred once every 30 minutes.

The dry powder obtained by removing the solvent was processed for one hour at 400° C. in a 4 volume percent methane 96 volume percent nitrogen gas flow to conduct reductive decomposition of the Co salt or the Fe salt contained in the deposition of the particle surface.

The above step yielded a magnetic powder comprised of gathering core/shell magnetic particles with cores in the form of BaFe hard magnetic phase and shells in the form of a Co or Fe-containing soft magnetic phase.

### Comparative Example 2

With the exception that acetone was used instead of salt solution, magnetic powders were obtained by the same processing as in Examples 9 and 10.

### Comparative Example 3

With the exception that ethanol was used instead of the salt solution, magnetic powder was obtained by the same processing as in Examples 11 and 12.

Since no salt solution was employed in Comparative Example 2 or 3, BaFe magnetic particles were obtained that had no shells.

### Evaluation Methods (Evaluation of Magnetic Characteristics)

The magnetic characteristics of the magnetic powders comprised of core/shell magnetic particles obtained in Examples 9 to 12 and the magnetic powders of Comparative Examples 2 and 3 were evaluated under conditions of an applied magnetic field of 3,184 kA/m (40 kOe) with a superconducting vibrating sample magnetometer (VSM) made by Tamagawa Co. To prevent fast oxidation, the various magnetic powders were sealed in acrylic containers in nitrogen atmospheres for evaluation.

TABLE 2

| | | Quantity | | |
|---|---|---|---|---|
| | | of salt | | |
| | | per 100 g of | | |
| | | solution | Coercive | Saturation |
| Sample | Salt/solvent | (mmol) | force | magnetization |
| Ex. 9 | Cobalt chloride/ | 2 | 235 kA/m | 0.56 × 10⁻¹ A · m²/g |
| | acetone | | (2950 Oe) | (56 emu/g) |
| Ex. 10 | Cobalt chloride/ | 8 | 227 kA/m | 0.55 × 10⁻¹ A · m²/g |
| | acetone | | (2850 Oe) | (55 emu/g) |
| Ex. 11 | Iron chloride/ | 2 | 231 kA/m | 0.55 × 10⁻¹ A · m²/g |
| | ethanol | | (2900 Oe) | (55 emu/g) |
| Ex. 12 | Iron chloride/ | 8 | 223 kA/m | 0.54 × 10⁻¹ A · m²/g |
| | ethanol | | (2800 Oe) | (54 emu/g) |
| Comp. Ex. 2 | None/acetone | 0 | 271 kA/m | 0.51 × 10⁻¹ A · m²/g |
| | | | (3400 Oe) | (51 emu/g) |
| Comp. Ex. 3 | None/ethanol | 0 | 267 kA/m | 0.52 × 10⁻¹ A · m²/g |
| | | | (3350 Oe) | (52 emu/g) |

### Evaluation Results

In the evaluation of the above magnetic characteristics, the fact that no shift corresponding to the coercive force of the soft magnetic phase appeared in the hysteresis loops obtained by evaluation of the magnetic characteristics of Examples 9 to 12 was confirmed. From these results, it was determined that magnetic particles in which a soft magnetic phase and a hard magnetic phase had exchange-coupled had been obtained in Examples 9 to 12. In Table 2, the magnetic powders of Comparative Examples 2 and 3 exhibited coercive force nearly equivalent to that of the unprocessed BaFe powder. By contrast, the fact that the coercive force of the magnetic powders of Examples 9 to 12 was lower than the coercive force (270 kA/m) of the unprocessed BaFe powder was the result of exchange coupling of the soft magnetic phase and the hard magnetic phase on the surface of the BaFe particles (hard magnetic phase) in the magnetic powders of Example 9 to 12. This result indicated improved recording properties. In the magnetic powders of Examples 9 to 12, the saturation magnetization was higher than that of the unprocessed BaFe powder as indicated in Table 2. This result also indicated that the recording properties had been improved through exchange coupling of the hard magnetic phase and the soft magnetic phase.

Evaluation Method (Gradient of Attenuation of Magnetization Over Time, Activation volume)

The gradient of attenuation of magnetization over time due to demagnetizing fields of 400 Oe (about 32 kA/m) and 600 Oe (about 48 kA/m) corresponding to the demagnetizing fields to which a magnetic recording medium is subjected during storage, and the activation volume for a demagnetizing field of 500 Oe (about 40 kA/m) were calculated by the following procedure with a superconducting electromagnet vibrating sample magnetometer (model TM-VSM1450-SM made by Tamagawa Co.) for the magnetic powders of Examples 9 to 12 and Comparative Examples 2 and 3. In each measurement, the sample employed was 0.1 g of magnetic powder that was compacted in a measurement holder.

### (1) Gradient of Attenuation of Magnetization Over Time

In the case of thermal fluctuation magnetic aftereffects, ΔM/(Int₁−Int₂) becomes constant in the attenuation of magnetization over time. Since magnetization also varies depending on the magnetic field, the gradient of the attenuation of magnetization over time was determined by measuring the magnetization once each increment of time after the magnetic field had been stabilized.

Specifically, an external magnetic field of 40 kOe (about 3,200 kA/m) was applied to the sample. Following direct-current erasure, the magnet was controlled by means of current and current was supplied to generate the target demagnetizing field. The external magnetic field was gradually brought closer to the target demagnetizing field. This was to prevent the attenuation of magnetization over time from appearing to decrease due to stable processing by varying the external magnetic field.

Designating the time when the magnetic field had reached the target value as the base point in measurement, the magnetization was measured for 25 minutes once every 1 minute and the gradient of the attenuation of magnetization over time ΔM/(Int₁−Int₂) was obtained. The results are given in Table 3. In Table 3, the value given was obtained by dividing ΔM/(Int₁−Int₂) by the magnetization in a 40 kOe external magnetic field and normalizing the result.

### (2) Activation Volume

The magnetization was calculated 25 minutes after the target demagnetizing field was reached by the same procedure as in (1) above for demagnetizing fields H1 (400 Oe) and H2 (600 Oe) differing only by 200 Oe (about 16 kA/m). These magnetization levels were denoted as M_{B} and M_{E}, respectively, giving a total magnetization rate of Xtot=(M_{B}−M_{E})/ΔH=(M_{B}−M_{E})/200.

Next, reversible magnetization rate Xrev was obtained from Xrev=(M_{F}−M_{E})/ΔH=(M_{F}−M_{E})/200 by calculating the magnetization M_{F} when the external magnetic field from H2 was increased by 200 Oe.

Irreversible magnetization rate (Xirr) was obtained from Xirr=Xtot−Xrev.

The activation volume (Vact) was calculated from Vact=kT/(Ms(ΔM/Xirr(Int₁−Int₂)). In the above equation, k: Boltzmann constant; T: temperature; Ms: saturation magnetization of the sample.

Based on the above step, the activation volume was obtained at a demagnetization field of 500 Oe. The results are given in Table 3.

TABLE 3

| | Gradient of attenuation of | | |
|---|---|---|---|
| | magnetization over time | | Activation volume |
| | (l/ln(s)) | | (nm³) |
| | Demagnetizing | Demagnetizing | Demagnetizing |
| | field | field | field |
| | 400 Oe | 600 Oe | 500 Oe |
| Ex. 9 | −0.0030 | −0.0038 | 3000 |
| Ex. 10 | −0.0033 | −0.0030 | 2900 |
| Ex. 11 | −0.0033 | −0.0033 | 3100 |
| Ex. 12 | −0.0038 | −0.0038 | 2950 |
| Comp. Ex. 2 | −0.0030 | −0.0038 | 3000 |
| Comp. Ex. 3 | −0.0033 | −0.0033 | 2900 |

### Evaluation Results

The gradient of the attenuation of magnetization over time as measured by the above-described method is an index of the thermal stability of magnetic particles. As shown in Table 3, the gradient of the attenuation of magnetization over time of the magnetic powders of Examples 9 to 12 were nearly equivalent to those of Comparative Examples 2 and 3. From these results, it can be determined that exchange coupling of the hard magnetic phase and soft magnetic phase maintained the thermal stability of the magnetic particles without loss.

Further, the activation volume shown in Table 3 is an index of the presence or absence of aggregation. If aggregation were to have been present, a change would have appeared in the thousands place or higher. However, as shown in Table 3, the activation volumes of Examples 9 to 12 were nearly equivalent to those of Comparative Examples 2 and 3. From these results, it can be determined that no aggregation was produced in the step of exchange coupling the hard magnetic phase and the soft magnetic phase. From the above evaluation results, it can be determined that the core/shell magnetic particles in which a hard magnetic phase was exchange-coupled with a soft magnetic phase had good thermal stability, were microparticles that were nearly equivalent to hard magnetic particles prior to the formation of a soft magnetic phase, and were thus suited to high-density recording.

Errors in the hundreds place are known to occur in the activation volume. The numeric values of the activation voltage indicated in Table 3 were nearly equivalent for Examples 9 to 12 and Comparative Examples 2 and 3. However, in reality, the magnetic particles prepared in Examples 9 to 12 were thought to have greater volume by the amount of the shell that was present than the magnetic particles prepared in Comparative Examples 2 and 3. The reason this increase in volume was not reflected in the numeric values of the activation volume was presumed to be that the amount of the volume increase was buried in the above error portion.

### Evaluation of the Suitability of the Reducing Gas

BaFe powder comprised of the particles of BaFe (Hc: 270 kA/m, saturation magnetization: 5.2×10⁻² A·m²/g (52 emu/g), average plate diameter: 35 nm, average plate thickness: 8 nm) employed as the hard magnetic particles in Examples 9 to 12 was annealed for 10 minutes at the temperature given in Table 4 in the gas flow indicated in Table 4, after which the saturation magnetization was measured by the above-described method. The results are given in Table 4.

TABLE 4

| | Reducing gas | | |
|---|---|---|---|
| | H₂ | CH₄ | 10 vol % CO + 90 vol % N₂ |
| No annealing | 0.52 × 10⁻¹ A · m²/g | — | — |
| | (52 emu/g) | | |
| Annealing | 0.44 × 10⁻¹ A · m²/g | 0.52 × 10⁻¹ A · m²/g | 0.46 × 10⁻¹ A · m²/g |
| at 200° C. | (44 emu/g) | (52 emu/g) | (46 emu/g) |
| Annealing | 0.31 × 10⁻¹ A · m²/g | 0.51 × 10⁻¹ A · m²/g | 0.26 × 10⁻¹ A · m²/g |
| at 300° C. | (31 emu/g) | (51 emu/g) | (26 emu/g) |
| Annealing | 0.72 × 10⁻¹ A · m²/g | 0.51 × 10⁻¹ A · m²/g | 0.58 × 10⁻¹ A · m²/g |
| at 400° C. | (72 emu/g) | (51 emu/g) | (58 emu/g) |

### Evaluation Results

As indicated in Table 4, for the barium ferrite that was annealed in a hydrogen gas flow or in a carbon monoxide/nitrogen mixed gas flow, the saturation magnetization decreased up to an annealing temperature of 300° C. and the saturation magnetization increased at an annealing temperature of 400° C. This was presumed to be because the barium ferrite was reduced and decomposed due to the high reducing strength of hydrogen and carbon monoxide.

By contrast, barium ferrite that was annealed in a methane gas flow exhibited almost no change in saturation magnetization due to differences in the annealing temperature. This was attributed to the fact that barium ferrite was stable in the methane gas flow, and was not reduced or decomposed.

In the course of manufacturing the core/shell magnetic particles in which a hard magnetic phase is exchange-coupled with a soft magnetic phase by the manufacturing method of the present invention, the entire surface of the hard magnetic particles is not exposed to the reducing gas in the manner of the above evaluation because the reductive decomposition are conducted in a reducing gas atmosphere after the deposition containing a transition metal salt has been formed on the surface of the hard magnetic particles. However, since barium ferrite is presumed to have the property of being readily decomposed by reduction based on the above evaluation results, when a reducing gas of high reducing strength is employed, there is a possibility that even the area beneath the deposition will be decomposed by reduction and that magnetic characteristics such as the saturation magnetization will change. Accordingly, when employing an oxide such as barium ferrite as the hard magnetic particle, it is desirable to employ a reducing gas of relatively low reducing strength. From this perspective, a hydrocarbon, particularly methane, is desirably employed.

### Example 13

### Example Employing Barium Ferrite as Hard Magnetic Phase

Magnetic powder comprised of gathering BaFe particles (Hc: 247 kA/m (3,100 Oe), saturation magnetization: 4.6×10⁻² A·m²/g (46 emu/g), average plate diameter: 20.6 nm, average plate thickness: 6.1 nm, particle volume: 1,680 nm³) was immersed (3 g of solution per gram of magnetic particles) in 6 weight percent cobalt chloride solution (solvent: acetone) in such a manner as to wet the surface of the particles. The solvent was removed while reducing the pressure with an aspirator. In this process, the particles in the cobalt chloride solution were stirred once every 30 minutes.

The dry powder obtained by removing the solvent was treated for 17 hours at 350° C. in a 4 volume percent methane and 96 volume percent nitrogen gas flow to conduct reductive decomposition of the Co salt contained in the deposition of the particle surface.

The above steps yielded core/shell magnetic particles with cores of BaFe hard magnetic phase and shells of Co-containing soft magnetic phase.

### Evaluation Method

(1) Evaluation of the Composition by Scanning Transmission Electron Microscope (STEM)

The Co/Ba ratio and Cl/Ba ratio (both atomic ratios) of the magnetic particles obtained and of untreated starting material BaFe particles for reference were measured with a model HD2300 STEM (200 kV) made by Hitachi. The results are given in Table 5 below.

TABLE 5

Composition ratio

| Sample | Co/Ba | Cl/Ba |
|---|---|---|
| Untreated BaFe | 0 | 0 |
| (Reference) | | |
| Ex. 13 | 1.7 | 0.5 |

(2) Composition Evaluation by X-Ray Diffraction

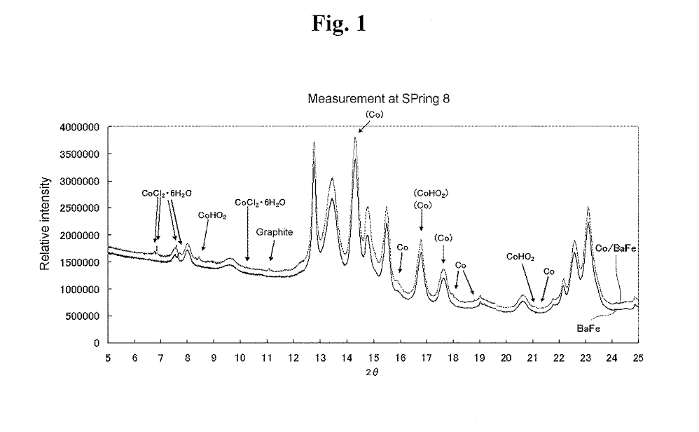

The composition of the magnetic particles obtained and of untreated starting material BaFe particles for reference was evaluated by X-ray diffraction analysis with a SPring-8 (Nb K edge wavelength 0.65297 Angstrom). The results are given in FIG. 1. The X-ray diffraction peaks were assigned using a library based on elements that could have potentially entered the test process.

(3) Coercive Force Evaluation

Evaluation of the coercive force of the magnetic powder comprised of the core/shell magnetic particles obtained in Example 13 under conditions of an applied magnetic field of 3,184 kA/m (40 kOe) with a superconducting vibrating sample magnetometer (VSM) made by Tamagawa Co. revealed a value of 146 kA/m (1,830 Oe). To prevent fast oxidation, the magnetic powder was sealed in an acrylic container in a nitrogen atmosphere for evaluation.

### Evaluation Results

As shown in Table 5, in contrast to no detection of Co in the starting material BaFe powder, Co and CoHO₂, the latter being a compound of cobalt, oxygen, and hydrogen, were detected in the magnetic powder obtained in Example 13. These results confirmed the fact that Co and CoHO₂ were deposited on the surface of the hard magnetic particles as a soft magnetic phase in Example 13. Since the transition metal salt employed to form the deposition in Example 13 did not contain an alkaline earth metal, neither did the soft magnetic phase that was formed. Since peaks were detected by X-ray diffraction, it was possible to confirm that Co and CoHO₂ were deposited as crystalline substances.

Since the coercive force of the magnetic powder of Example 13 was lower than that of the starting material BaFe powder, the presence of a soft magnetic phase exchange-coupled to a hard magnetic phase on the surface of the hard magnetic particles (hard magnetic phase) was confirmed in the magnetic powder of Example 13. As shown in Table 5, the presence of Cl in the magnetic powder of Example 13 was also confirmed. However, it was confirmed from the peak in the X-ray diffraction of FIG. 1 that this was caused by a portion of the cobalt chloride employed as a starting material of the soft magnetic phase remaining unreacted. When a portion of the starting material transition metal salt remained in the magnetic particles following reductive decomposition in this manner, washing and removing it with the solvent (acetone in Example 13) employed to prepare the solution of the transition metal salt, for example, was desirable to obtain magnetic particles with good magnetic characteristics. Although peaks corresponding to Co and Co salt appeared in the spectrum of the starting material BaFe powder shown in FIG. 1, they were background, and did not indicate that Co and Co salt were present in the starting material BaFe powder.

Further, the specific peak of graphite, which did not appear in the starting material BaFe powder, was detected in the magnetic powder of Example 13 as shown in FIG. 1. Based on these results, it was determined that conducting gas phase reductive decomposition in a hydrocarbon-containing (methane-containing) atmosphere yielded magnetic particles with a carbon component (graphite) present in the outermost layer.

The magnetic powder of the present invention is suitable for use in inexpensive particulate magnetic recording media.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. Magnetic powder comprised of gathering magnetic particles, wherein the magnetic particles comprise a hard magnetic particle and a soft magnetic material deposited on a surface of the hard magnetic particle in a state where the soft magnetic material is exchange-coupled with the hard magnetic particle.

2. The magnetic powder according to claim 1, which has a coercive force in a range of equal to or higher than 80 kA/m but less than 240 kA/m.

3. The magnetic powder according to claim 1, which has a saturation magnetization ranging from 4.0×10⁻² to 2.2 A·m²/g.

4. The magnetic powder according to claim 1, wherein a carbon component is present over the hard magnetic particle on which the soft magnetic material is deposited.

5. The magnetic powder according to claim 1, which has an oxide layer over the hard magnetic particle on which the soft magnetic material is deposited.

6. A method of manufacturing magnetic powder, wherein
the magnetic powder is the magnetic powder according to claim 1, and
the method comprises:
removing a solvent from a transition metal salt solution containing hard magnetic particles to form a deposition containing a transition metal salt on a surface of the hard magnetic particles, and
forming a soft magnetic phase containing a transition metal on the surface of the hard magnetic particles by reductive decomposition of the transition metal salt in the deposition.

7. The method of manufacturing magnetic powder according to claim 6, which comprises conducting oxidation treatment following the formation of the soft magnetic phase.

8. The method of manufacturing magnetic powder according to claim 6, wherein the reductive decomposition is conducted by heating the hard magnetic particles on which the deposition has been formed in a reducing gas flow.

9. The method of manufacturing magnetic powder according to claim 8, wherein the reducing gas is a hydrocarbon-containing gas.

10. The method of manufacturing magnetic powder according to claim 9, wherein the hydrocarbon is methane.

11. Magnetic powder comprised of gathering magnetic particles, wherein the magnetic particles comprise hexagonal ferrite and a substance deposited on a surface of the hexagonal ferrite, the substance being selected from the group consisting of a transition metal and a compound of a transition metal and oxygen.

12. The magnetic powder according to claim 11, wherein the compound comprises no alkaline earth metal.

13. The magnetic powder according to claim 11, wherein the transition metal is cobalt.

14. The magnetic powder according to claim 11, wherein the compound is CoHO₂.

15. The magnetic powder according to claim 11, wherein a carbon component is present in an outermost layer.

16. The magnetic powder according to claim 1, which is magnetic powder employed in a particulate magnetic recording medium.

17. The magnetic powder according to claim 11, which is magnetic powder employed in a particulate magnetic recording medium.
